(19) United States
(12) Patent Application Publication
(10) Pub. No.: US 2026/0369638 A1
(43) Pub. Date: Nov. 19, 2026

(54) FUEL CELL SYSTEM

(71) Applicant: TOYOTA JIDOSHA KABUSHIKI KAISHA, Toyota-shi (JP)

(72) Inventors: Keisuke YOKOTA, Nissin-shi (JP); Shuya Kawahara, Toyota-shi (JP); Yuta Ikehata, Toyota-shi (JP); Makito Okumura, Nagoya-shi (JP); Koro Fujio, Toyota-shi (JP); Shota Magome, Toyota-shi (JP); Tohru Oda, Toyota-shi (JP)

(73) Assignee: TOYOTA JIDOSHA KABUSHIKI KAISHA, Toyota-shi (JP)

(21) Appl. No.: 19/551,988

(22) Filed: Feb. 27, 2026

(30) Foreign Application Priority Data
May 16, 2025 (JP) 2025-082786

(51) Int. Cl. H01M 8/04537; H01M 8/04029; H01M 8/0432

(52) U.S. Cl. CPC H01M 8/04589; H01M 8/04029; H01M 8/04358; H01M 8/04559

(57) ABSTRACT

A fuel cell system includes a fuel cell stack, a cooling device, a refrigerant supply channel, a refrigerant return channel, a temperature sensor, a current sensor, a voltage sensor, and a control device. The control device executes a lower limit voltage value setting process of setting a lower limit voltage value for a stack voltage based on a detection temperature and a detection current, a limit current value setting process of setting, as a limit current value for a stack current, a detection current at a time at which a detection voltage is below the lower limit voltage value, and a limiting process of limiting output power of the fuel cell stack such that the detection current is equal to or smaller than the limit current value.

### CROSS-REFERENCE TO RELATED APPLICATION

This application claims priority to Japanese Patent Application No. 2025-082786 filed on May 16, 2025. The disclosure of the above-identified application, including the specification, drawings, and claims, is incorporated by reference herein in its entirety.

### BACKGROUND

### 1. Technical Field

The technology disclosed in the present specification relates to a fuel cell system.

### 2. Description of Related Art

Japanese Unexamined Patent Application Publication No. 11-144749 (JP 11-144749 A) discloses a fuel cell system. This fuel cell system includes a fuel cell stack, a current sensor that detects a stack current of the fuel cell stack, a voltage sensor that detects a stack voltage of the fuel cell stack, and a control device that limits output power of the fuel cell stack based on a detection voltage from the voltage sensor.

### SUMMARY

Regarding a current-voltage characteristic (IV characteristic) of a fuel cell stack, the stack voltage of the fuel cell stack decreases as the stack current of the fuel cell stack increases. Therefore, it is possible to suppress overheating of the fuel cell stack by setting a lower limit voltage value for the stack voltage of the fuel cell stack and limiting the output power of the fuel cell stack such that the stack voltage does not fall below the lower limit voltage value. Hitherto, the lower limit voltage value for the stack voltage has been set to the same value regardless of the temperature of the fuel cell stack.

However, the IV characteristic of the fuel cell stack changes as the deterioration of the fuel cell stack advances. Specifically, the stack voltage decreases at the same stack current as the deterioration of the fuel cell stack advances more. Therefore, before the deterioration of the fuel cell stack advances, the stack current when the stack voltage decreases to the lower limit voltage value may be a relatively large value. Thus, even when the stack voltage is maintained at or above the lower limit voltage value, the temperature of the fuel cell stack becomes relatively high. Accordingly, the deterioration of the fuel cell stack may be accelerated.

After the deterioration of the fuel cell stack advances, the stack current when the stack voltage decreases to the lower limit voltage value may be a relatively small value. Thus, when the stack voltage is maintained at or above the lower limit voltage value, the stack current is limited to a relatively small value. Accordingly, the output power of the fuel cell stack may be limited excessively.

In view of the above, the present specification provides a technology that can suppress deterioration of a fuel cell stack while suppressing overheating of the fuel cell stack.

In a first aspect of the present technology, a fuel cell system may include: a fuel cell stack; a cooling device configured to cool a refrigerant; a refrigerant supply channel through which the refrigerant is supplied from the cooling device to the fuel cell stack; a refrigerant return channel through which the refrigerant that has passed through the fuel cell stack returns to the cooling device; a temperature sensor that is provided in the refrigerant return channel and is configured to detect a refrigerant temperature that is a temperature of the refrigerant; a current sensor configured to detect a stack current of the fuel cell stack; a voltage sensor configured to detect a stack voltage of the fuel cell stack; and a control device configured to limit output power of the fuel cell stack based on a detection temperature from the temperature sensor, a detection current from the current sensor, and a detection voltage from the voltage sensor. The control device may be configured to execute: a lower limit voltage value setting process of setting a lower limit voltage value for the stack voltage based on the detection temperature and the detection current; a limit current value setting process of setting, as a limit current value for the stack current, a detection current at a time at which the detection voltage is below the lower limit voltage value; and a limiting process of limiting the output power of the fuel cell stack such that the detection current is equal to or smaller than the limit current value.

With the above configuration, the lower limit voltage value is set for the stack voltage, and therefore overheating of the fuel cell stack is suppressed. In particular, the lower limit voltage value for the stack voltage is set based on the temperature (refrigerant temperature) of the fuel cell stack. Thus, it is possible to allow or limit heat generation in the fuel cell stack based on the temperature of the fuel cell stack, and to effectively suppress deterioration of the fuel cell stack. In addition, the lower limit voltage value for the stack voltage is also set based on the stack current of the fuel cell stack. As described above, regarding the IV characteristic of the fuel cell stack, the stack voltage decreases as the stack current increases. By setting the lower limit voltage value for the stack voltage based on the stack current, it is possible to appropriately limit the output power of the fuel cell stack in consideration of the IV characteristic of the fuel cell stack.

In a second aspect, in the first aspect described above, in the lower limit voltage value setting process, when the detection current is the same, the lower limit voltage value may be set to a larger value as the detection temperature increases.

With this configuration, it is possible to suppress heat generation in the fuel cell stack by limiting the stack current to a smaller value as the temperature of the fuel cell stack increases.

In a third aspect, in the second aspect described above, in the lower limit voltage value setting process, when the detection temperature is below a first predetermined temperature, the lower limit voltage value may be set to a predetermined fixed value regardless of the detection current, and when the detection temperature is above the first predetermined temperature, the lower limit voltage value may be set to a smaller value as the detection current increases.

With the above configuration, the lower limit voltage value can be appropriately set based on the temperature of the fuel cell stack. In particular, when the temperature of the fuel cell stack is above the first predetermined temperature, a lower limit voltage value that can appropriately suppress the temperature increase of the fuel cell stack can be accurately set in accordance with the IV characteristic of the fuel cell stack. When the temperature of the fuel cell stack is below the first predetermined temperature, the temperature increase of the fuel cell stack is allowable. Therefore, the process of the control device can be simplified by fixing the lower limit voltage value.

In a fourth aspect, in the third aspect described above, when the detection temperature is a second predetermined temperature that is higher than the first predetermined temperature, a relationship between the detection current and the lower limit voltage value that is set in correspondence with the detection current may coincide with an IV characteristic of the fuel cell stack at the second predetermined temperature.

With the above configuration, the output power of the fuel cell stack can be appropriately limited while suppressing the occurrence of a case where the temperature of the fuel cell stack is above the second predetermined temperature.

In a fifth aspect, in the fourth aspect described above, the predetermined fixed value may be based on an IV characteristic of the fuel cell stack at a third predetermined temperature that is higher than the second predetermined temperature.

By using the IV characteristic of the fuel cell stack at the third predetermined temperature, it is possible to set the lower limit voltage value such that the heat generation amount in the fuel cell stack is smaller than an allowable heat generation amount. Thus, it is possible to suppress the occurrence of a case where the heat generation amount in the fuel cell stack is larger than the allowable heat generation amount.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the configuration of a fuel cell system 2;

FIG. 2 is a diagram showing an example of a lower limit voltage value map 92;

FIG. 3 is a diagram showing IV characteristics of a fuel cell stack 4;

FIG. 4 is a diagram showing an example of an upper limit current value map 94; and

FIG. 5 is a flowchart of a limit current value determination process.

### DETAILED DESCRIPTION OF EMBODIMENTS

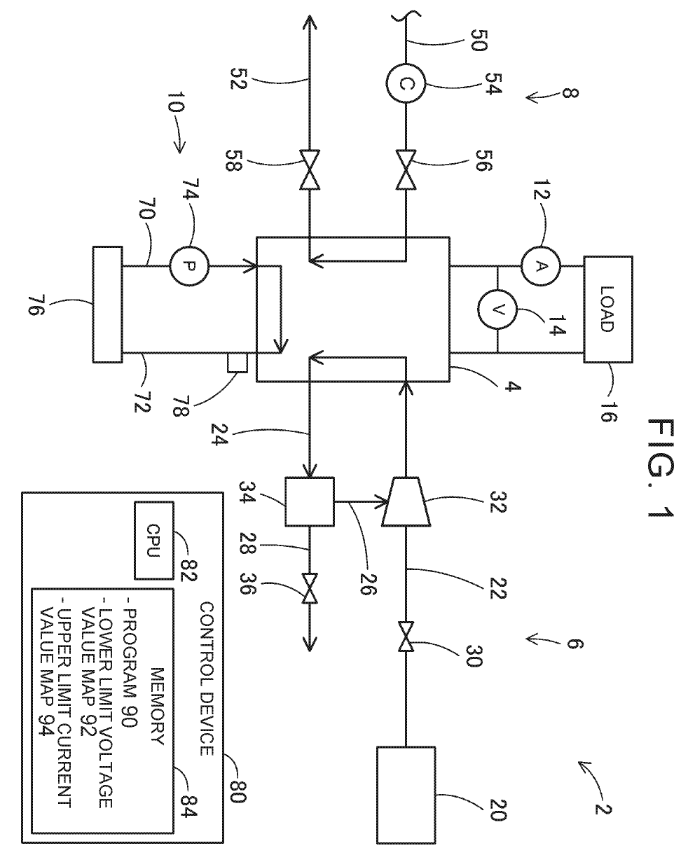

A fuel cell system 2 will be described with reference to FIG. 1. The use of the fuel cell system 2 is not particularly limited. In one example, the fuel cell system 2 may be a mobile fuel cell system that is mounted on a mobile body such as a vehicle or ship, or a stationary fuel cell system that is used in a stationary power generation facility.

The fuel cell system 2 includes a fuel cell stack 4, a fuel gas supply unit 6, an air supply unit 8, a cooling unit 10, a current sensor 12, a voltage sensor 14, and a control device 80. The fuel gas supply unit 6 supplies fuel gas (hydrogen gas) to the fuel cell stack 4. The air supply unit 8 supplies air serving as oxidant gas to the fuel cell stack 4. The cooling unit 10 cools the fuel cell stack 4 using a refrigerant (e.g., a coolant).

The fuel cell stack 4 is a device that generates electric power through a chemical reaction between hydrogen and oxygen. Water is generated through the chemical reaction between hydrogen and oxygen. An output terminal of the fuel cell stack 4 is connected to a load 16. The electric power generated by the fuel cell stack 4 is supplied to the load 16. The load 16 may be of various types. In one example, the load 16 is a motor for a mobile body or any of various power conversion devices such as a DC/DC converter. The current sensor 12 and the voltage sensor 14 are provided in an output path of the fuel cell stack 4. The current sensor 12 detects a stack current of the fuel cell stack 4. The voltage sensor 14 detects a stack voltage of the fuel cell stack 4.

The fuel gas supply unit 6 includes a fuel tank 20, a fuel gas supply channel 22, a fuel gas discharge channel 24, a circulation channel 26, an exhaust/drainage channel 28, an injector 30, an ejector 32, a gas-liquid separator 34, and an exhaust/drainage valve 36.

The fuel gas supply channel 22 connects the fuel tank 20 and the fuel cell stack 4. The fuel gas supply channel 22 is provided with the injector 30 and the ejector 32. The injector 30 adjusts the flow rate of the fuel gas supplied from the fuel tank 20 to the fuel cell stack 4. The ejector 32 is provided between the injector 30 and the fuel cell stack 4.

The fuel gas discharge channel 24 connects the fuel cell stack 4 and the gas-liquid separator 34. The fuel gas discharge channel 24 is a channel for discharging water generated in the fuel cell stack 4 and exhaust gas discharged from the fuel cell stack 4. Hereinafter, the exhaust gas will be referred to as "fuel off-gas."

The circulation channel 26 connects the gas-liquid separator 34 and the ejector 32. The circulation channel 26 is a channel for supplying the fuel off-gas to the ejector 32.

The upstream end of the exhaust/drainage channel 28 is connected to the gas-liquid separator 34. The exhaust/drainage channel 28 is provided with the exhaust/drainage valve 36. When the exhaust/drainage valve 36 is opened, water is discharged to the outside through the exhaust/drainage channel 28. The fuel off-gas from the gas-liquid separator 34 is also discharged to the outside through the exhaust/drainage channel 28 together with the water.

The air supply unit 8 includes an air supply channel 50, an air discharge channel 52, an air compressor 54, a sealing valve 56, and a pressure regulating valve 58.

The upstream end of the air supply channel 50 is open to the outside, and the downstream end of the air supply channel 50 is connected to the fuel cell stack 4. The air supply channel 50 is provided with the air compressor 54 and the sealing valve 56. The sealing valve 56 is disposed between the air compressor 54 and the fuel cell stack 4.

The upstream end of the air discharge channel 52 is connected to the fuel cell stack 4, and the downstream end of the air discharge channel 52 is connected to a location for discharging the air and water after the reaction. The pressure regulating valve 58 is provided in the air discharge channel 52.

The cooling unit 10 includes a refrigerant supply channel 70, a refrigerant return channel 72, a pump 74, and a radiator 76.

The upstream end of the refrigerant supply channel 70 is connected to the radiator 76, and the downstream end of the refrigerant supply channel 70 is connected to the fuel cell stack 4. The refrigerant supply channel 70 is provided with the pump 74.

The upstream end of the refrigerant return channel 72 is connected to the fuel cell stack 4, and the downstream end of the refrigerant return channel 72 is connected to the radiator 76. A temperature sensor 78 is provided at the upstream end of the refrigerant return channel 72 to detect a refrigerant temperature that is the temperature of the refrigerant. The temperature sensor 78 detects the temperature of the refrigerant discharged from the fuel cell stack 4. Since the temperature sensor 78 is provided at the upstream end of the refrigerant return channel 72, the temperature of the refrigerant detected by the temperature sensor 78 can be assumed to be the temperature of the fuel cell stack 4.

The control device 80 includes a CPU 82 and a memory 84. The memory 84 includes a volatile memory and a non-volatile memory. The CPU 82 controls the operation of each part of the fuel cell system 2 based on a program 90 stored in the memory 84. The memory 84 further stores a lower limit voltage value map 92 and an upper limit current value map 94.

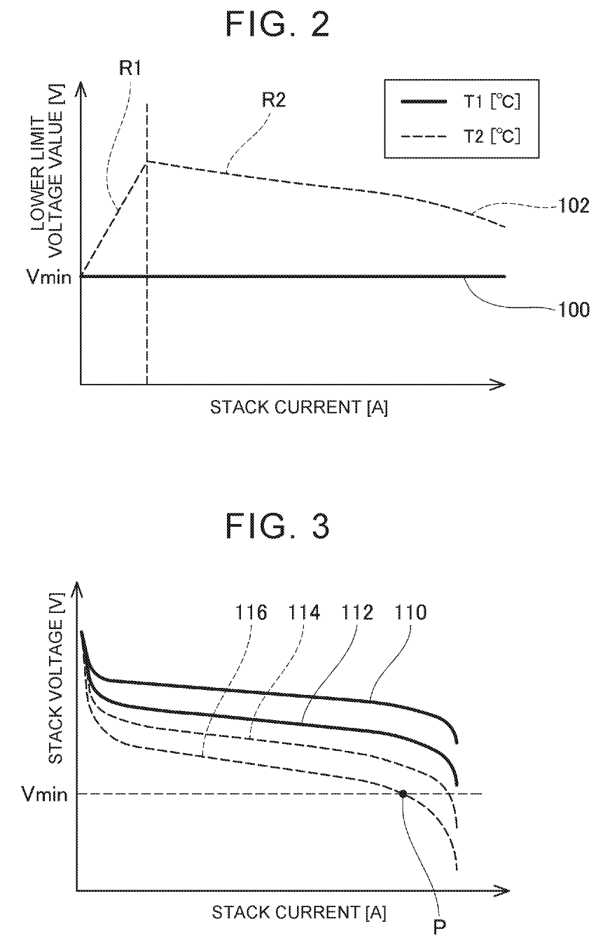

The lower limit voltage value map 92 will be described with reference to FIG. 2. The lower limit voltage value map 92 is a map for determining a lower limit voltage value to be used in a limit current value determination process in FIG. 5 using the refrigerant temperature and the stack current. The lower limit voltage value map 92 includes a first reference line 100 corresponding to a lower limit voltage value when the refrigerant temperature is below a first predetermined temperature T1, and a second reference line 102 corresponding to a lower limit voltage value when the refrigerant temperature is above a second predetermined temperature T2. The first reference line 100 is a line indicating the minimum value of the lower limit voltage value, and the second reference line 102 is a line indicating the maximum value of the lower limit voltage value. The second predetermined temperature T2 is higher than the first predetermined temperature T1. In one example, the first predetermined temperature T1 and the second predetermined temperature T2 are "80°C" and "95°C," respectively.

The first reference line 100 and the second reference line 102 are set based on an IV characteristic of the fuel cell stack 4 in a high-temperature region. Therefore, the IV characteristic of the fuel cell stack 4 in the high-temperature region will be described first with reference to FIG. 3. FIG. 3 shows four IV characteristics 110, 112, 114, 116 of the fuel cell stack 4. The horizontal axis represents the stack current [A], and the vertical axis represents the stack voltage [V]. The IV characteristics 110, 112 are an IV characteristic of the fuel cell stack 4 in a brand new state at the second predetermined temperature T2 and an IV characteristic of the fuel cell stack 4 in the brand new state at a third predetermined temperature T3, respectively. The third predetermined temperature T3 is higher than the second predetermined temperature T2. In one example, the third predetermined temperature T3 is "100°C." The IV characteristics 114, 116 are an IV characteristic of the fuel cell stack 4 in a deteriorated state at the second predetermined temperature T2 and an IV characteristic of the fuel cell stack 4 in the deteriorated state at the third predetermined temperature T3, respectively. As shown in FIG. 3, in each of the IV characteristics, the stack voltage decreases as the stack current increases. The IV characteristic deteriorates as the fuel cell stack 4 deteriorates. The phrase "IV characteristic deteriorates" means that the stack voltage is low at the same stack current. In the high-temperature region, the IV characteristic deteriorates as the temperature of the fuel cell stack 4 increases. The IV characteristics 110, 112, 114, 116 are determined through experiment, simulation, etc.

Next, the first reference line 100 and the second reference line 102 in FIG. 2 will be described. The lower limit voltage value on the first reference line 100 is constant at a minimum voltage value Vmin regardless of the stack current. The minimum voltage value Vmin is set based on the IV characteristic 116 (see FIG. 3) of the fuel cell stack 4 in the deteriorated state at the third predetermined temperature T3. Specifically, as shown in FIG. 3, a voltage value corresponding to a thermal load point P corresponding to an allowable heat generation amount in the IV characteristic 116 is determined as the minimum voltage value Vmin.

The second reference line 102 includes a first region R1 in which the lower limit voltage value increases as the stack current increases, and a second region R2 in which the lower limit voltage value decreases as the stack current increases. The first region R1 includes a low-load region, and the second region R2 includes a medium-load region and a high-load region. The lower limit voltage value in the first region R1 changes linearly. The lower limit voltage value in the second region R2 changes nonlinearly. Specifically, the lower limit voltage value in the second region R2 coincides with the IV characteristic 114 (see FIG. 3) of the fuel cell stack 4 in the deteriorated state at the second predetermined temperature T2.

Lower limit voltage values when the refrigerant temperature is between the first predetermined temperature T1 and the second predetermined temperature T2 are determined by linear interpolation between the first reference line 100 and the second reference line 102.

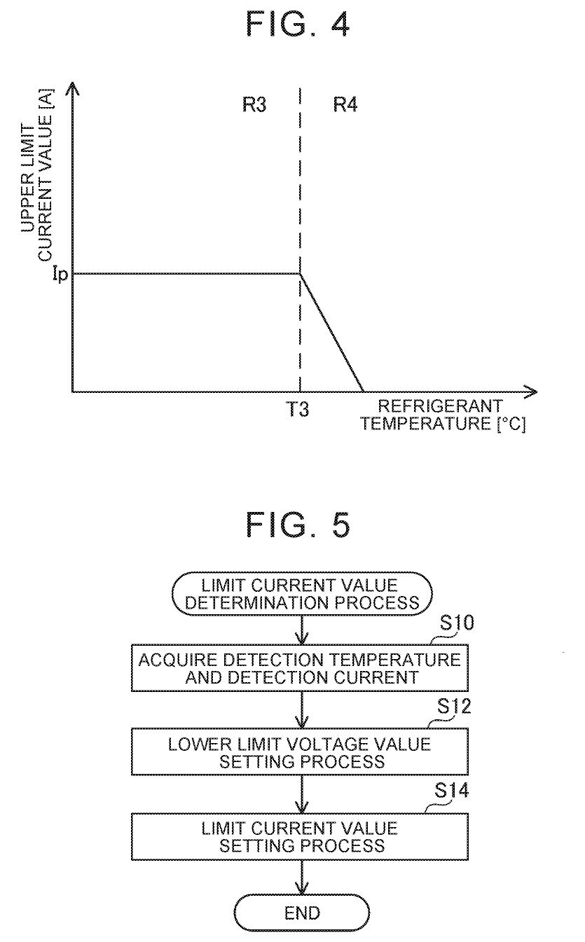

The upper limit current value map 94 will be described with reference to FIG. 4. The upper limit current value map 94 is a map for determining an upper limit current value using the refrigerant temperature.

The upper limit current value map 94 includes a third region R3 on a lower-temperature side relative to the third predetermined temperature T3, and a fourth region R4 on a higher-temperature side relative to the third predetermined temperature T3. In the third region R3, the upper limit current value is constant at a predetermined current value Ip regardless of the refrigerant temperature. In one example, the predetermined current value Ip is a value that is larger than a stack current at the thermal load point P in FIG. 3 and smaller than a stack current determined by the stack voltage at the thermal load point P and the IV characteristic 112. In the fourth region R4, the upper limit current value decreases as the refrigerant temperature increases.

### Limit Current Value Determination Process: FIG. 5

The limit current value determination process to be executed by the control device 80 will be described with reference to FIG. 5. The control device 80 executes the process in FIG. 5 at predetermined intervals.

In S10, the control device 80 acquires a detection temperature (refrigerant temperature) from the temperature sensor 78 and a detection current (stack current) from the current sensor 12.

In S12, the control device 80 executes a lower limit voltage value setting process using the lower limit voltage value map 92 in the memory 84, the acquired detection temperature, and the acquired detection current. Specifically, the control device 80 sets a voltage value corresponding to the detection temperature and the detection current in the lower limit voltage value map 92 as the lower limit voltage value.

In S14, the control device 80 executes a limit current value setting process. In the limit current value setting process, the control device 80 monitors whether the detection voltage (stack voltage) from the voltage sensor 14 is below the lower limit voltage value. When the detection voltage is below the lower limit voltage value, the control device 80 sets a detection current at that time as a limit current value. When S14 ends, the control device 80 ends the process in FIG. 5. In the limit current value setting process, when a predetermined period has elapsed while the stack voltage is not below the lower limit voltage value, the control device 80 ends the process in FIG. 5.

### Limiting Process

The control device 80 executes a limiting process using the limit current value determined in the limit current value determination process in FIG. 5 and the upper limit current value determined based on the upper limit current value map 94. The limiting process is a process of limiting the output of the fuel cell stack 4 to suppress the thermal load on the fuel cell stack 4. Specifically, the control device 80 instructs the load 16 to sweep a load current such that the current is equal to or smaller than the limit current value and the upper limit current value. As a result, the stack current becomes equal to or smaller than the limit current value and the upper limit current value, and the output power of the fuel cell stack 4 is limited.

When the fuel cell stack 4 is in a brand new state, the output of the fuel cell stack 4 is limited mainly by the upper limit current value, and when the fuel cell stack 4 is in a deteriorated state, the output of the fuel cell stack 4 is limited mainly by the limit current value.

### Effects of Embodiment

As described above, the fuel cell system 2 includes the fuel cell stack 4, the radiator 76 (an example of "cooling device") that cools the refrigerant, the refrigerant supply channel 70 through which the refrigerant is supplied from the radiator 76 to the fuel cell stack 4, the refrigerant return channel 72 through which the refrigerant that has passed through the fuel cell stack 4 returns to the radiator 76, the temperature sensor 78 that is provided in the refrigerant return channel 72 and detects the refrigerant temperature that is the temperature of the refrigerant, the current sensor 12 that detects the stack current of the fuel cell stack 4, the voltage sensor 14 that detects the stack voltage of the fuel cell stack 4, and the control device 80 that limits the output power of the fuel cell stack 4 based on the detection temperature from the temperature sensor 78, the detection current from the current sensor 12, and the detection voltage from the voltage sensor 14. The control device 80 executes the lower limit voltage value setting process (S12 in FIG. 5) of setting the lower limit voltage value for the stack voltage based on the detection temperature and the detection current, the limit current value setting process (S14) of setting, as the limit current value for the stack current, the detection current at the time at which the detection voltage is below the lower limit voltage value, and the limiting process of limiting the output power of the fuel cell stack 4 such that the detection current is equal to or smaller than the limit current value.

With the above configuration, the lower limit voltage value is set for the stack voltage, and therefore overheating of the fuel cell stack 4 is suppressed. In particular, the lower limit voltage value for the stack voltage is set based on the temperature (refrigerant temperature) of the fuel cell stack 4. Thus, it is possible to allow or limit heat generation in the fuel cell stack 4 based on the temperature of the fuel cell stack 4, and to effectively suppress deterioration of the fuel cell stack 4.

The lower limit voltage value for the stack voltage is also set based on the stack current of the fuel cell stack 4. Regarding the IV characteristic of the fuel cell stack 4, the stack voltage decreases as the stack current increases. By setting the lower limit voltage value for the stack voltage based on the stack current, it is possible to appropriately limit the output power of the fuel cell stack 4 in consideration of the IV characteristic of the fuel cell stack 4.

In the lower limit voltage value setting process, when the detection current is the same, the lower limit voltage value is set to a larger value as the detection temperature increases.

With this configuration, it is possible to suppress heat generation in the fuel cell stack 4 by limiting the stack current to a smaller value as the temperature of the fuel cell stack 4 increases.

[ 0052 ] In the lower limit voltage value setting process, when the detection temperature is below the first predetermined temperature T1, the lower limit voltage value is set to the minimum voltage value Vmin (an example of "predetermined fixed value") regardless of the detection current, and when the detection temperature is above the first predetermined temperature T1, the lower limit voltage value is set to a smaller value as the detection current increases.

With the above configuration, the lower limit voltage value can be appropriately set based on the temperature of the fuel cell stack 4. In particular, when the temperature of the fuel cell stack 4 is above the first predetermined temperature T1, a lower limit voltage value that can appropriately suppress the temperature increase of the fuel cell stack 4 can be accurately set in accordance with the IV characteristic of the fuel cell stack 4. When the temperature of the fuel cell stack 4 is below the first predetermined temperature T1, the temperature increase of the fuel cell stack 4 is allowable. Therefore, the process of the control device 80 can be simplified by fixing the lower limit voltage value.

When the detection temperature is the second predetermined temperature T2 that is higher than the first predetermined temperature T1, the relationship between the detection current and the lower limit voltage value that is set in correspondence with the detection current coincides with the IV characteristic 114 of the fuel cell stack 4 at the second predetermined temperature T2.

With the above configuration, the output power of the fuel cell stack 4 can be appropriately limited while suppressing the occurrence of a case where the temperature of the fuel cell stack 4 is above the second predetermined temperature T2.

In particular, in the present embodiment, it is possible to suppress the occurrence of a case where the temperature of the fuel cell stack 4 is above the second predetermined temperature T2 when the fuel cell stack 4 deteriorates. Thus, it is possible to increase the output of the fuel cell stack 4 compared to a case where the temperature of the fuel cell stack 4 reaches the third predetermined temperature T3.

The minimum voltage value Vmin is based on the IV characteristic 116 of the fuel cell stack 4 at the third predetermined temperature T3.

By using the IV characteristic 116 of the fuel cell stack 4 at the third predetermined temperature T3, it is possible to set the lower limit voltage value such that the heat generation amount in the fuel cell stack 4 is smaller than the allowable heat generation amount. With the above configuration, it is possible to suppress the occurrence of a case where the heat generation amount in the fuel cell stack 4 is larger than the allowable heat generation amount.

Although specific examples of the disclosure have been described in detail above, the examples are merely examples and do not limit the scope of claims. The technology described in the claims includes various modifications and variations of the specific examples described above.

### First Modification

The first reference line 100 of the lower limit voltage value map 92 may change depending on the stack current.

### Second Modification

The second region R2 of the second reference line 102 of the lower limit voltage value map 92 may correspond to the IV characteristic 110, an average value of the IV characteristic 110 and the IV characteristic 114, etc. In the second region R2 of the second reference line 102, the lower limit voltage value may change linearly.

The technical elements described in the present specification or in the drawings exhibit technical usefulness alone or in various combinations, and are not limited to the combinations described in the claims at the time of filing the application. In addition, the technology illustrated in the present specification or in the drawings may simultaneously achieve a plurality of objects, and the achievement of any one of the objects alone provides technical usefulness.

What is claimed is:

1. A fuel cell system comprising:
a fuel cell stack;
a cooling device configured to cool a refrigerant;
a refrigerant supply channel through which the refrigerant is supplied from the cooling device to the fuel cell stack;
a refrigerant return channel through which the refrigerant that has passed through the fuel cell stack returns to the cooling device;
a temperature sensor that is provided in the refrigerant return channel and is configured to detect a refrigerant temperature that is a temperature of the refrigerant;
a current sensor configured to detect a stack current of the fuel cell stack;
a voltage sensor configured to detect a stack voltage of the fuel cell stack; and
a control device configured to limit output power of the fuel cell stack based on a detection temperature from the temperature sensor, a detection current from the current sensor, and a detection voltage from the voltage sensor, wherein
the control device is configured to execute:
a lower limit voltage value setting process of setting a lower limit voltage value for the stack voltage based on the detection temperature and the detection current;
a limit current value setting process of setting, as a limit current value for the stack current, a detection current at a time at which the detection voltage is below the lower limit voltage value; and
a limiting process of limiting the output power of the fuel cell stack such that the detection current is equal to or smaller than the limit current value.

2. The fuel cell system according to claim 1, wherein, in the lower limit voltage value setting process, when the detection current is the same, the lower limit voltage value is set to a larger value as the detection temperature increases.

3. The fuel cell system according to claim 2, wherein, in the lower limit voltage value setting process,
when the detection temperature is below a first predetermined temperature, the lower limit voltage value is set to a predetermined fixed value regardless of the detection current, and
when the detection temperature is above the first predetermined temperature, the lower limit voltage value is set to a smaller value as the detection current increases.

4. The fuel cell system according to claim 3, wherein, when the detection temperature is a second predetermined temperature that is higher than the first predetermined temperature, a relationship between the detection current and the lower limit voltage value that is set in correspondence with the detection current coincides with an IV characteristic of the fuel cell stack at the second predetermined temperature.

5. The fuel cell system according to claim 4, wherein the predetermined fixed value is based on an IV characteristic of the fuel cell stack at a third predetermined temperature that is higher than the second predetermined temperature.
